(19) United States
(12) Patent Application Publication
(10) Pub. No.: US 2006/0262140 A1
(43) Pub. Date: Nov. 23, 2006

(54) Method and apparatus to facilitate visual augmentation of perceived reality

(76) Inventors: Gregory A. Kujawa, St. Charles, IL (US); Mohamed Imtiaz Ahmed, Glendale Heights, IL (US); Nikos Bellas, Chicago, IL (US); Sek M. Chai, Streamwood, IL (US); King F. Lee, Schaumburg, IL (US); Abelardo Lopez Lagunas, Toluca (MX)

Correspondence Address: MOTOROLA, INC., 1303 EAST ALGONQUIN ROAD, IL01/3RD, SCHAUMBURG, IL, 60196, US

(21) Appl. No.: 11/132,124

(22) Filed: May 18, 2005

(51) Int. Cl. G09G 5/00

(52) U.S. Cl. 345/633

(57) ABSTRACT

A visual reality augmentation apparatus (300) comprises one or more (substantially) real time reality context input stages (301, 302) that provide corresponding reality context information to a reality content detector (303). The latter provides detected object information to an augmented reality content display (304) that provides augmentation information (via, for example, projection display techniques) to augment the real world scene being viewed by a viewer. In a preferred approach a direction-of-gaze detector (305) detects the viewer's gaze direction. That information then serves to facilitate positional synchronization of the augmentation information to the viewer's point of view of the corresponding real world information.

### TECHNICAL FIELD

This invention relates generally to visual displays and more particularly to real time displays that relate to reality.

### BACKGROUND

Sight comprises one of the typically acknowledged five human senses and constitutes, for many individuals, a primary means of facilitating numerous tasks including, but not limited to, piloting a vehicle, operating machinery, and so forth. In particular, sight provides a significant mechanism by which a given individual, such as a vehicle driver, gains information regarding an immediate reality context (such as, for example, a road upon which the vehicle driver is presently navigating their vehicle).

Individuals seem to vary with respect to the amount of visual information that they are able to usefully process within a given period of time. Furthermore, essentially all individuals are subject to some upper limit with respect to their cognitive loading capabilities. Unfortunately, these limitations may not be sufficient to ensure that a given individual, in a given reality context, will successfully process the available visual information to thereby properly inform a corresponding necessary response or action. As a result, suboptimum results, including but not limited to accidents, may occur.

Other related factors and concerns also exist. For example, individuals vary with respect to the experience that they bring to their viewing of a particular reality context. An inexperienced viewer may, in turn, be unable to correctly prioritize the elements that comprise the scene before them in a timely manner. This, again, can lead to suboptimum results.

### BRIEF DESCRIPTION OF THE DRAWINGS

The above needs are at least partially met through provision of the method and apparatus to facilitate visual augmentation of visually perceived reality described in the following detailed description, particularly when studied in conjunction with the drawings, wherein:

FIG. 1 comprises a flow diagram as configured in accordance with various embodiments of the invention;

FIG. 2 comprises a schematic front elevational view as configured in accordance with various embodiments of the invention;

FIG. 3 comprises a block diagram as configured in accordance with various embodiments of the invention;

FIG. 4 comprises a block diagram as configured in accordance with various embodiments of the invention;

FIG. 5 comprises a block diagram as configured in accordance with various embodiments of the invention;

FIG. 6 comprises a schematic front elevational view as configured in accordance with various embodiments of the invention;

FIG. 7 comprises a schematic side elevational view as configured in accordance with various embodiments of the invention;

FIG. 8 comprises a schematic top plan view as configured in accordance with various embodiments of the invention;

FIG. 9 comprises a schematic front elevational view as configured in accordance with various embodiments of the invention; and

FIG. 10 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the arts will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, information regarding a given reality context within a given field of view (such as the actual or likely field of view of a given viewer) is captured (preferably substantially in real time). That information is then processed (again, preferably, substantially in real time) to provide detected reality content for that given field of view (such as, for example, object edges and the like). That detected reality content is then used (preferably substantially in real time) to provide visually perceivable reality content augmentation to a person viewing the given field of view. In a preferred approach this augmentation is positionally visually synchronized with respect to at least one element of the given reality context and relative to the viewer's point of view.

Such augmentation can serve, in turn, to aid the viewer in understanding what is being viewed (either in an absolute sense or with respect to time) and/or to better prioritize the meaning and impact of the viewed content. Such augmentation can provide, for example, the driver of a vehicle with useful information to aid that driver in safely navigating that vehicle with respect to ordinary and/or extraordinary conditions and hazards.

By one approach the augmentation can be provided to supplement the view of a person through a transparent surface such as a vehicle's windscreen. As another approach the augmentation can supplement a person's view of a mirror (such as a vehicle's rear view or side view mirror). The augmentation itself can assume any of a wide variety of static and/or animated forms but will, in general, serve to supplement an ordinary view of the reality context rather than to substitute for it.

In a preferred embodiment, one also captures (preferably substantially in real time) information regarding a viewer's present gaze direction with respect to the given field of view. That information regarding the viewer's present gaze direction is then usable to facilitate the aforementioned positional synchronization between the given reality context as viewed by the viewer and the visually perceivable reality content augmentation.

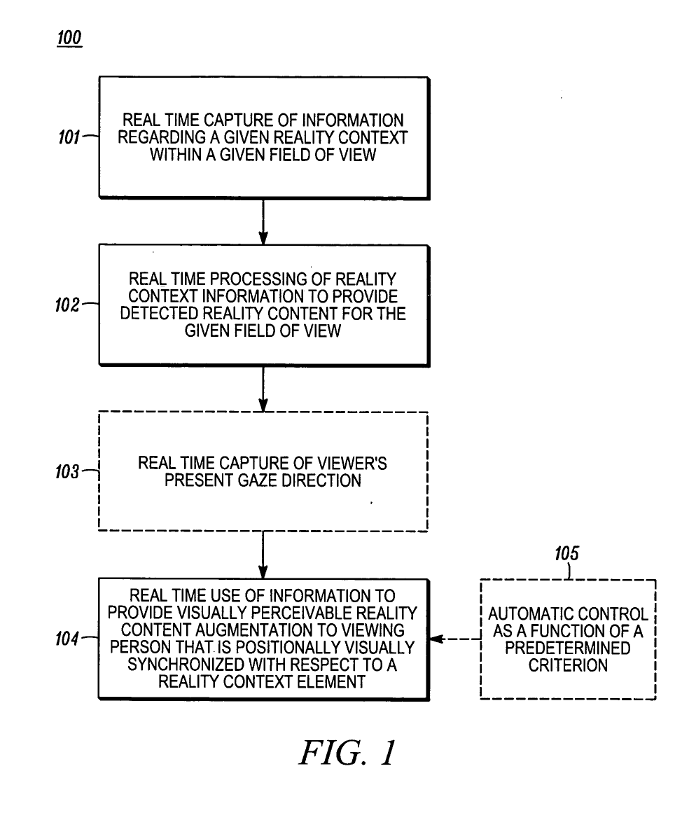

These and other benefits may become clearer upon making a thorough review and study of the following detailed description. Referring now to the drawings, and in particular to FIG. 1, a preferred process 100 comprises capturing 101, substantially in real time, information regarding a given reality context within a given field of view. The given field of view can comprise, for example, a forward-looking view as corresponds to a vehicle operator's view while operating a vehicle (such as through a vehicle windscreen), a rearward-looking view as corresponds to a vehicle operator's view while operating a vehicle (such as through a rear window of a vehicle), or a mirrored view as corresponds to a vehicle operator's view while operating a vehicle (such as a mirrored view as corresponds to a rearview mirror or a side view mirror of a vehicle).

Such information can be captured using any available and suitable capture mechanism such as a video camera. For many applications it may be desirable to employ a plurality of cameras to capture various (though perhaps overlapping) views of the given reality context. When employing multiple cameras, the cameras can be essentially identical to one another (but differently placed in order to provide at least somewhat differing views of the given reality context) or can be different from one another to facilitate capturing potentially different information regarding the given reality context (for example, one camera might comprise a visible light camera and another might comprise an infrared sensitive camera).

For many applications it may be satisfactory to use cameras having an essentially fixed or automatic field and/or depth of view. In other cases, however, it may be useful to use at least one camera having a dynamically alterable field and/or depth of view to facilitate specific data gathering and/or analysis tasks.

This process 100 then provides for processing 102 this information, substantially in real time, to provide resultant detected reality content for the given field of view. The precise nature of this processing can and likely will vary from application to application and may even vary dynamically with respect to a given application as needs dictate. This processing can comprise, but is certainly not limited to, processing the information to detect at least one of:

one or more object edges (such as the edge of a roadway or the edge of another vehicle);

one or more object shapes (such as the shape of a roadway sign);

an object's distance (such as whether a particular roadway sign is relatively near or far to the viewer);

relative positions of a plurality of objects (such as whether a first object is in front of, or to the side of, a second object);

textual information (such as roadway signage textual content, vehicle license numbers, and so forth);

object recognition (such as whether a given object is a vehicle or a pedestrian);

one or more colors; and

one or more temporally dynamic objects;

to name but a few. (Such content processing and detection comprises a relatively well-understood area of endeavor and further relevant developments are no doubt to be expected in the future. Furthermore, as these teachings are not particularly sensitive to the selection of any particular technique or combination of techniques in this regard, further description and elaboration regarding such processing and detection will not be provided here except where particularly relevant to the description below.)

As an optional but preferred step, this process 100 can also accommodate capturing 103, substantially in real time, information regarding a viewer's present gaze direction with respect to the given field of view mentioned above. Various eye movement and direction-of-gaze detection techniques and mechanisms are known in the art and may be usefully employed here for this purpose. It may also be useful in some settings to support such detection through supplemental or substituted use of head orientation detection as is also known in the art. (As used herein, “gaze direction” and like expressions shall be understood to mean both gaze directionality as well as head orientation and relative position.) In general, the point here is to ascertain to what extent a given viewer's personal field of view matches, or fails to match, the content of the given captured field (or fields) of view. For example, when the given field of view comprises a forwarding looking view through a vehicle windscreen it can be useful to detect when the driver is presently gazing through a side window and not through that forward windscreen.

This process 100 then uses 104, substantially in real time, the detected reality content for the given field of view to provide visually perceivable reality content augmentation to a person viewing the given field of view. In a preferred embodiment this augmentation is positionally visually synchronized with respect to at least one element of the given reality content. To accomplish the latter the aforementioned information regarding the viewer's present gaze direction can be usefully employed. For example (and as will be described in more detail below), information regarding the viewer's present gaze direction can be used to shift positioning of the augmentation information to facilitate maintaining the position of that augmentation information with respect to a given element within the observed reality context. This can include (but is not limited to) translating, rotating, and/or otherwise skewing the visually perceivable reality content augmentation based on at least one of present (or recent) eye orientation of the viewer, the head position of that viewer, and/or a distance that separates the viewer's eyes (or a selected eye) from the display of the augmentation information.

The augmentation information itself can vary widely with the needs of a given application setting. Examples include, but are not limited to, use of a blinking (or other animated) property, a solid property, a selectively variable opaqueness property, one or more selected colors, and so forth, to name but a few, and can be presented as a line, a curve, a two-dimensional shape, or even text as desired. Other possibilities exist as well.

This augmentation is preferably delivered to the viewer through use of a display wherein the display can comprise, for example, a substantially transparent surface (such as a vehicle operator's windscreen, corrective lens eyewear, or even sunglasses) or a mirror (such as the side or rear view mirrors offered in many vehicles). The display itself can comprise a projected display. There are various known ways to accomplish such projection, such as laser projection platforms, and others are likely to be developed in the future. These teachings are likely useful with many such platforms.

The particular augmentation provided in a given application may be relatively fixed. That is, the augmentation provided upon detecting a particular element within a given reality context will not vary. If desired, however, and as an optional embellishment, this process 100 can also accommodate automatically controlling 105 provision of the visually perceivable reality content augmentation as a function of one or more predetermined criteria of interest. For example, whether to provide augmentation and/or the nature and type of augmentation can be based, at least in part, upon such factors as:

a level of confidence with respect to likely accuracy of the detected reality content for the given field of view;

a distance to a detected object;

a personal preference of the person (to require, or to prohibit, for example, augmentation for particular objects when detected);

the viewer's level of experience with respect to a particular activity;

a person's level of skill with respect to a particular activity;

a person's age;

how visible, or occluded, a given object might presently be without augmentation; and/or

one or more environmental conditions of interest or concern; to name a few.

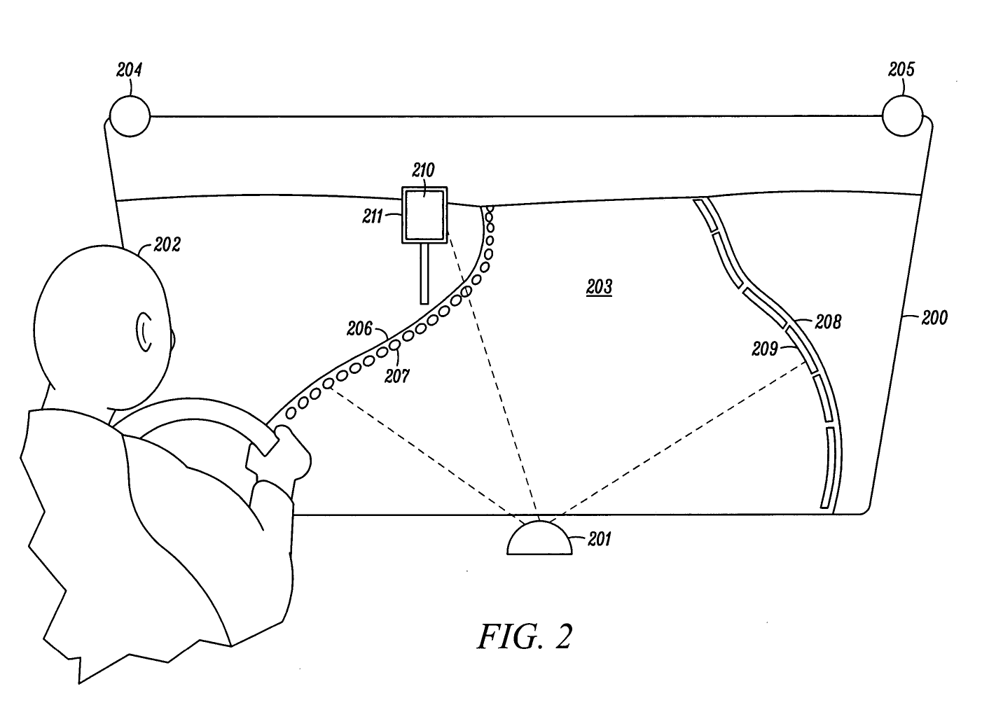

So configured, and referring now to FIG. 2, a projection display mechanism 201 (mounted, for example, on the dashboard of an automobile and configured to project augmentation information onto the windscreen 200 of that vehicle) can project augmentation information to augment, for a viewer 202 comprising, in this example, the driver of that vehicle, that viewer's view of a forward-looking reality context 203. In the embodiment shown, only a single projection display mechanism is depicted. It should be understood, however, that these teachings are no so limited. Instead, if desired, these teachings can be employed with a plurality of display mechanisms that produce, in the aggregate, a display of the desired augmented reality view.

In this example, the edges 206 and 208 of the roadway are augmented as is a roadway sign 210. As noted earlier, this augmentation can vary in form for any number of static and/or dynamic reasons. In this example, for illustration purposes only, a first roadway edge 206 is augmented with a positionally synchronized line of blinking dots 207 while the opposite roadway edge 208 is augmented with a positionally synchronized dashed line 209. The roadway sign 210 is augmented with a colored border 211. Those skilled in the art will appreciate that numerous other augmentation styles and forms are possible and that these particular examples are offered only for the purpose of illustration and not as an exhaustive example.

In this particular example, interior gaze detection detectors 204 and 205 serve to monitor the present gaze of the viewer 202. That information, in turn, permits the augmentation information to be positionally synchronized with respect to the reality context elements that they individually augment. In other words, this gaze direction information aids in ensuring that the viewer sees the augmentation information (for example, the augmentation information 207 that augments the left edge 206 of the roadway) in close proximity to the real life element being augmented notwithstanding movement of the viewer, the viewer's head, and/or movement of the viewer's eyes and hence their gaze.

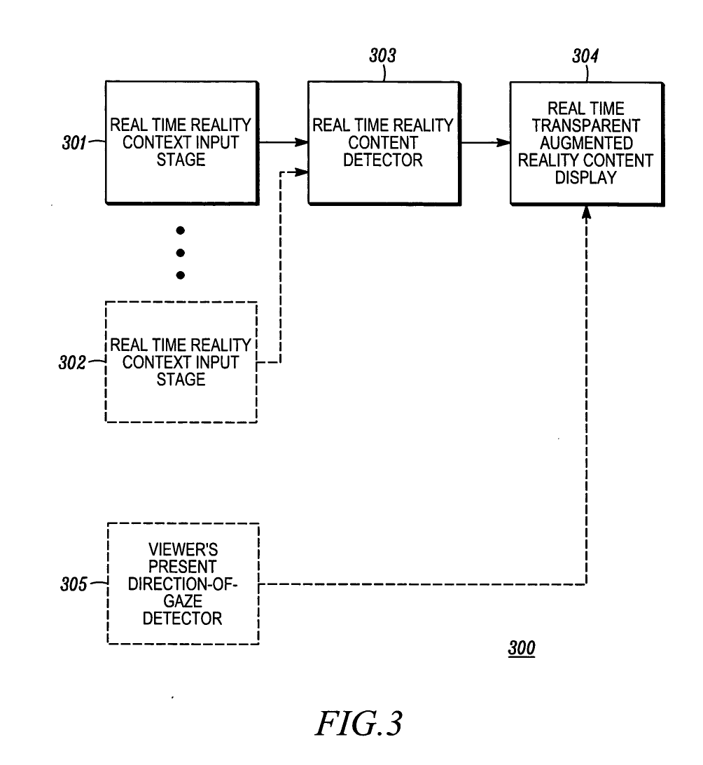

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

A visual reality augmentation apparatus 300 may comprise a substantially real time reality context input stage 301 having a corresponding field of view input and a captured reality context information output that feeds a substantially real time reality content detector 303. As noted above, there may be at least one additional reality context input stage 302 to provide different (though often at least partially overlapping) fields of view with respect to a given reality context. For example, other cameras, radar, ultrasonic sensors, and other sensors might all be suitable candidates for a given application. Various devices of this sort are presently known and others are likely to be hereafter developed. Further elaboration in this regard will therefore be avoided for the sake of brevity.

The reality content detector 303 serves in this embodiment to detect the object (or objects) of interest within the captured views of the reality context. This can comprise, for example, detecting the edges of a roadway, roadway signs, and so forth. This apparatus 300 then further preferably comprises a substantially real time augmented reality content display 304 that further comprises, in this embodiment, a substantially transparent display (such as, for example, a vehicle's windscreen). So configured, the reality content detector 303 can detect one or more objects of interest as appear within a viewer's field of view and the augmented reality content display 304 can then present (via, for example, a projection display) corresponding selective augmentation with respect to that object such that the viewer now views both the object and it's corresponding augmentation.

In a preferred embodiment at least some of the augmentation is positionally synchronized to one or more elements within the real world field of view. To facilitate this approach, the apparatus 300 can optionally further comprise a viewer's present direction-of-gaze detector 305. This detector 305 serves to detect a viewer's present gaze direction and to provide corresponding information to the augmented reality content display 304. This configuration, in turn, permits the latter to positionally synchronize at least one real object within the field of view with a corresponding augmentation element as a function, at least in part, of the viewer's gaze direction and/or a relative position of the viewer's eyes with respect to the display itself.

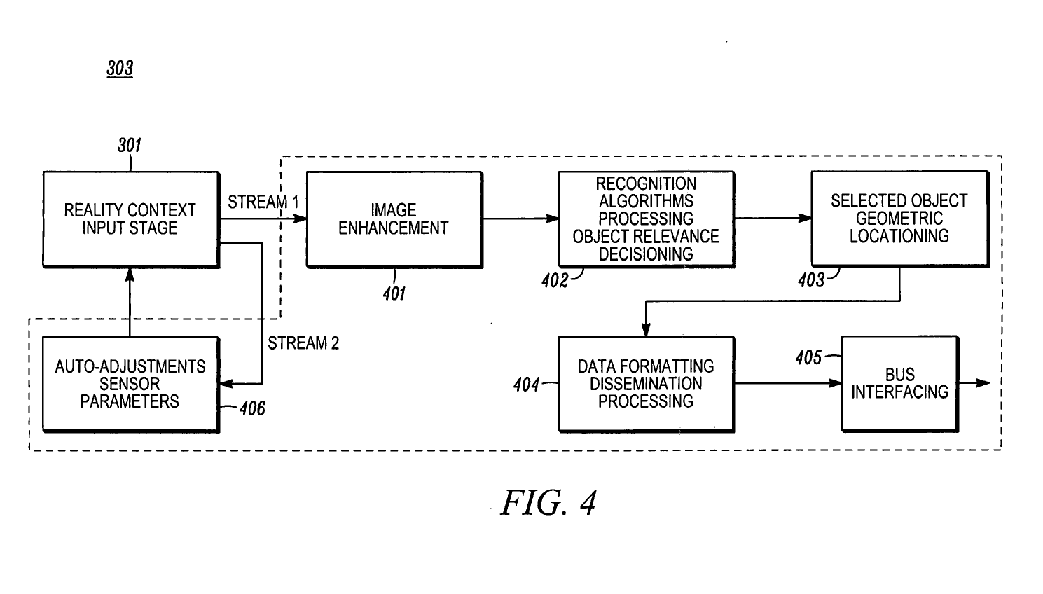

Referring now to FIG. 4, the reality content detector 303 can comprise a partially or wholly programmable platform and/or a fixed purpose apparatus as may best suit the needs of a given design setting. As one illustrative example, this reality content detector 303 can comprise an image enhancement stage 401 to enhance the incoming captured images from the reality context input stage 301. This can comprise, for example, automated contrast adjustments, color correction, brightness control, and so forth. Such image enhancement can serve, for example, to better prepare the captured image for subsequent object detection.

The image enhancement stage 401 feeds a next stage 402 that uses recognition algorithms of choice to process the captured image and recognize specific objects presented in that captured image. If desired, this stage 402 can also make decisions regarding the relevance of one or more recognized objects (based, for example, upon prioritization criteria as has been previously supplied by a system designer or operator). Such relevancy determinations can serve, for example, to control what information is passed on for subsequent processing in accordance with these teachings.

A next stage 403 then locates selected objects with respect to a geometric frame of reference of choice. This frame of reference can be purely dynamic (as when objects are simply located with respect to one another) or, less desirably, can be at least partially based upon an independent point of reference as may have been previously established as a calibration step by a system operator. This location information can serve to later facilitate stitching together information from various image capture input stages and/or when positionally synchronizing augmentation information to such objects.

In this illustrative embodiment a next stage 404 then formats the resultant data regarding detected objects and their geometric locations to facilitate subsequent dissemination (using, for example, the strictures of a data protocol format of choice). The resultant formatted data is then disseminated using, for example, a bus interfacing stage 405 (with various such interfaces being well known in the art). (Using a common bus, of course, would also permit the various input stages to communicate their acquired information amongst themselves if desired. This could include sharing of geometric information as well as other details related to specific detected objects within the reality context.)

If desired, such an apparatus may further comprise an automatic adjustment sensor stage 406 that receives the same (or a different, if desired) output data stream from the reality context input stage 301 and provides feedback control to the latter as is based upon an analysis of the output thereof. This feedback can be based, for example, upon a comparison of the captured image data with parameters regarding points of interest such as a desired brightness or contrast range. The reality context input stage 301, in turn, can use this feedback to alter its applied image capture parameters.

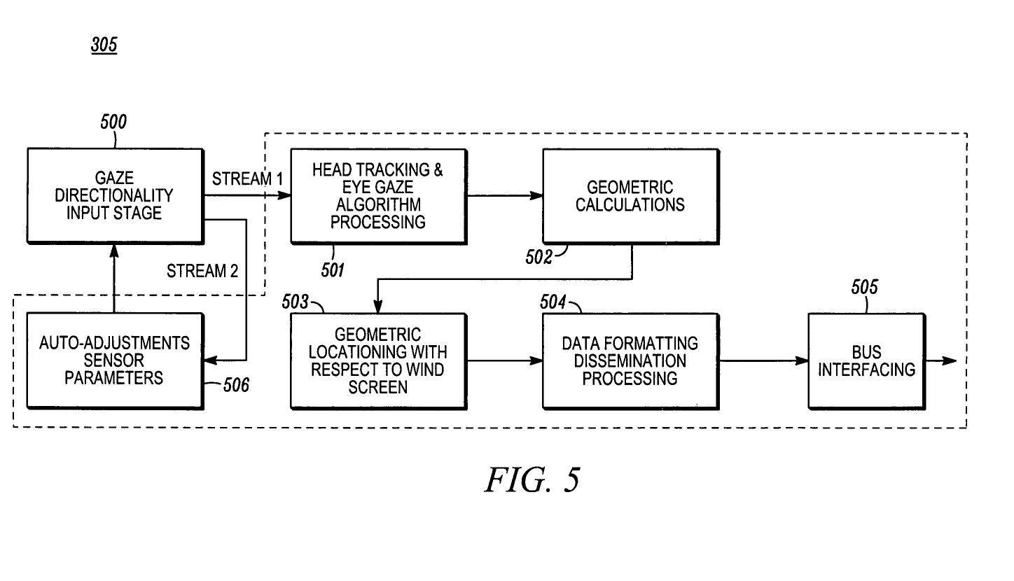

Referring now to FIG. 5, the direction-of-gaze detector 305 can receive input from a gaze directionality input stage 500. This information regarding the viewer can then be processed by a tracking stage 501 that tracks eye gaze and head movement/positioning using one or more tracking algorithms of choice. In a preferred approach, both eye and head position are tracked with respect to a plurality of relative criteria using, for example, at least one camera.

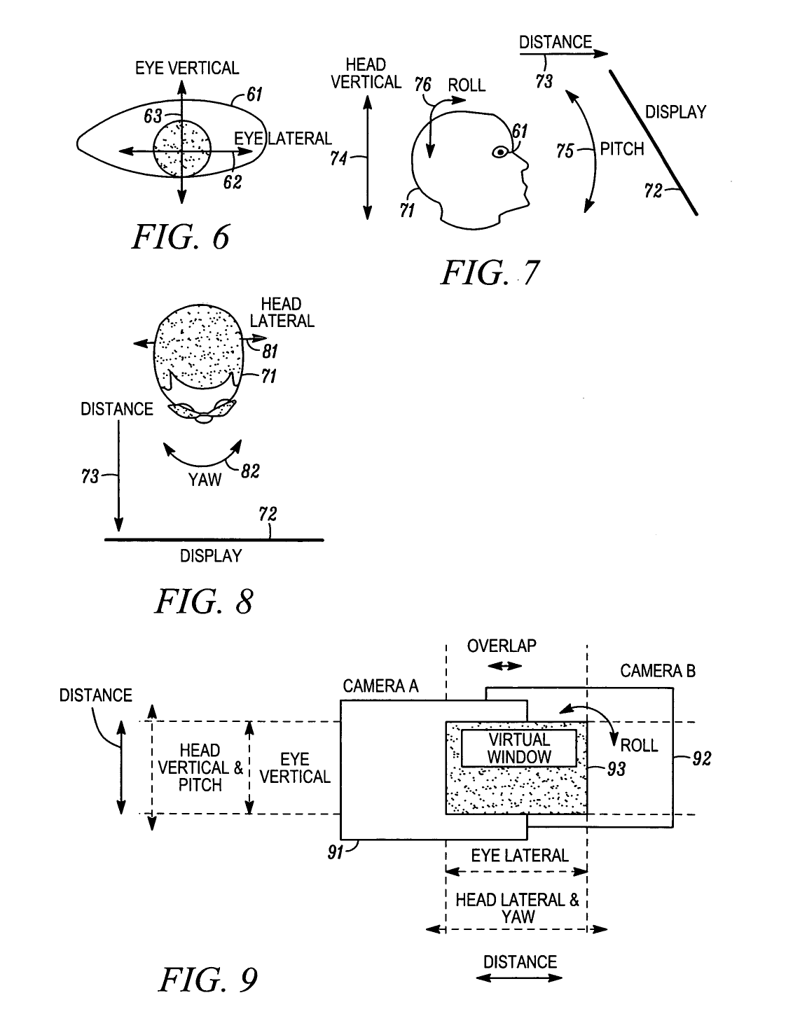

For example, and making momentary reference to FIG. 6, both lateral 62 and vertical 63 movement of the eye 61 (or eyes) of a monitored viewer can be independently tracked using known or hereafter-developed techniques. With momentary reference to FIG. 7, one can also track the distance 73 that separates the head 71 (and/or the eyes 61) of the viewer from the display surface 72 (such as the windscreen of a vehicle being driven by the viewer). With continued reference to FIG. 7, one can further track the vertical position 74 of the viewer's head 71 as well as both pitch 75 and roll 76 as pertains thereto. Furthermore, and making momentary reference now to FIG. 8, lateral positioning 81 and yaw 82 as pertains to the viewer's head 71 can also be tracked and considered.

Returning again to FIG. 5, such tracking data is then preferably used by a calculation stage 502 that develops location information that is then used by a locationing stage 503. The latter stage 503 serves to establish positioning of the viewer's likely gaze (and hence, personal point of view) with respect to the display (comprising, in this example, the windscreen of the viewer's automobile). The resultant geometric data is then formatted for dissemination in a formatting stage 504 and provided via a bus interfacing stage 505 to the augmented reality content display 304. (Using a common bus, of course, would again permit these input stages to communicate their acquired information amongst themselves if desired. This could include sharing of gaze direction information as well as other details related to the viewer.)

A primary point, then, can comprise projecting the augmentation information onto the display such that the augmentation information is, for example, juxtaposed with a corresponding real world object as seen from the point of view of the viewer. This, in turn, can comprise shifting the augmentation representation from a first position (which presumes a beginning point of view of, say, one or more of the image capture platforms) to a second position which matches that of the viewer.

In one example embodiment, this juxtaposition with detected reality content can be achieved by graphical manipulation using techniques such as translation, rotation, skewing, scaling, and cropping of the images obtained via the reality content input 301. The amount of graphical manipulation is, in general, derived from the gaze direction and viewpoint of the reality content input 301. Using terms typically used in computer graphics as are well known in the art, the matrices that define the transformation include the relative distance between the viewpoint of the reality content input 301 and the viewer's eyes/head, and the amount of rotation about the display 203 such that the reality content input 301 overlaps with the eyes/head.

With reference to FIG. 9, and presuming for the sake of illustration a two camera reality context input platform, the above elements serve to provide information regarding a first reality context field of view 91 and a second, partially overlapping reality context field of view 92 (wherein these two views correspond to the views captured from the point of view of the two respective cameras). Geometric information is also provided regarding the direction-of-gaze of the viewer (based, for example, upon gaze directionality and/or head position information) which in turn corresponds to a particular individual and local field of view for the viewer. Using all of this information one can then select and establish a virtual window 93 within which the augmentation information is displayed.

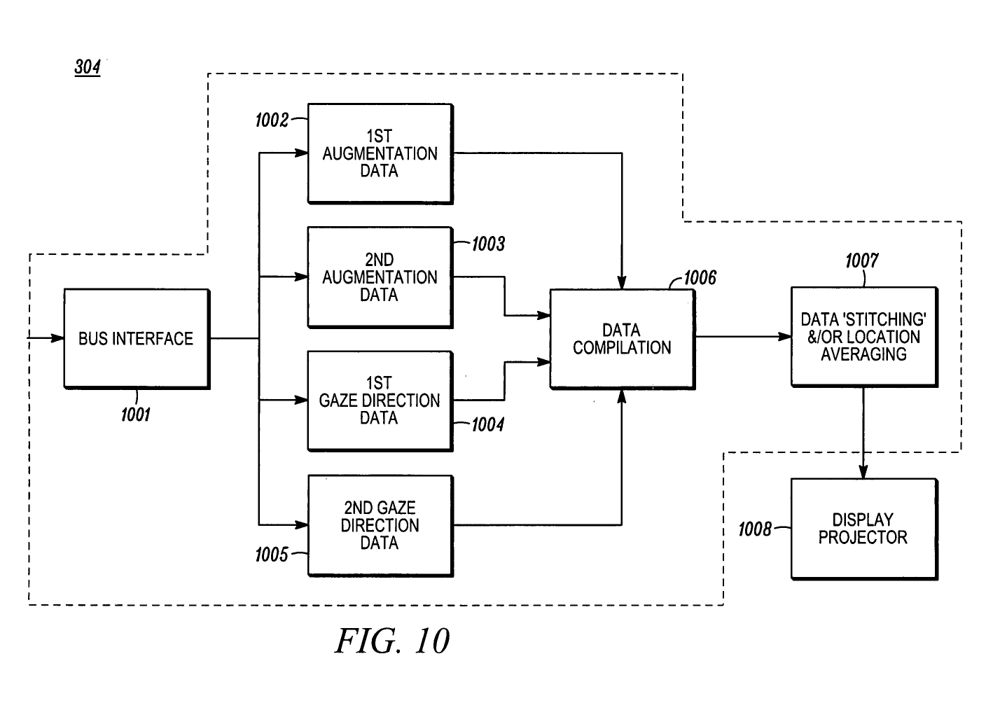

Referring now to FIG. 10, the previously mentioned augmented reality content display 304 facilitates these results by receiving such information via a bus interface 1001 and using a data compilation stage 1006 to aggregate and assemble the incoming data streams. In particular, in this illustrative example (which presumes the use of two field-of-view cameras and two viewer cameras to assess gaze/head direction), this information comprises first and second augmentation data 1002 and 1003 and first and second gaze direction data 1004 and 1005.

If desired, another stage 1007 can be employed to effect stitching of image data as is contributed by multiple sources (and/or location averaging can be used to combine the information from multiple sources in this context). At least one display projector 1008 of choice then projects the augmentation information such that the augmentation information (or at least selected portions thereof) appears positionally synchronized with real world objects from the viewpoint of the viewer. In a preferred embodiment, this occurs substantially in real time such that the positional synchronicity persists notwithstanding viewer eye and head movement. When using more than one such projector it will likely be preferred to permit such projectors to communicate and synchronize with one another via a bus interface to thereby aid in ensuring a single seamless view for the viewer.

Those skilled in the art will recognize that literal “real time” processing and display is not necessary to successfully impart a convincing temporally and spatially synchronized view of augmentation data as juxtaposed with respect to a viewer's present view of a given reality context; therefore, “substantially” real time processing will suffice so long as the resultant augmentation is reasonably synchronized with respect to the viewer's ability to perceive that augmentation in combination with corresponding real world objects.

So configured, a given viewer can view a real world context with as little, or as much, real time augmentation as may be desired or useful in a given setting. Importantly, if desired, this augmentation can be positionally synchronized with respect to one or more elements of that real world scene. So, for example, augmentation to highlight the side of a roadway can appear in close juxtaposition to that roadway side notwithstanding that the viewer and the image capture mechanisms do not share a common point of view and even notwithstanding changes with respect to the viewer's direction-of-gaze and/or the position of the viewer with respect to the display. These teachings are also employable with a wide variety of input platforms and processing techniques and algorithms.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, as already noted above, the provision augmentation can be dynamically adjusted based on such things as user preference, gaze detection information, and/or reality content detection. In a more particular embodiment, a user could selectively switch the display augmentation on or off and thereby enable or disable the provision of visually perceivable reality content augmentation. As another example, a type and/or degree of augmentation or other output (such as, but not limited to, supplemental audible augmentation or annunciation) could be selected from a set of possibilities based on user experience and/or relative skill. As yet another example, inboard cameras could be used to detect a user's age, present level of attention, or the like while outboard cameras (or other information sources) could be used to detect external content with both being used to inform the selection of a particular type of output from a set of candidate outputs.

We claim:

1. A method comprising:
capturing, substantially in real time, information regarding a given reality context within a given field of view;
processing, substantially in real time, the information regarding a given reality context to provide detected reality content for the given field of view;
using, substantially in real time, the detected reality content for the given field of view to provide visually perceivable reality content augmentation to a person viewing the given field of view wherein the visually perceivable reality content augmentation is positionally visually synchronized with respect to at least one element of the given reality context.

2. The method of claim 1 wherein the given field of view comprises at least one of:
a forward-looking view as corresponds to a vehicle operator's view while operating a vehicle;
a rearward-looking view as corresponds to a vehicle operator's view while operating a vehicle;
a mirrored view as corresponds to a vehicle operator's view while operating a vehicle.

3. The method of claim 1 wherein capturing, substantially in real time, information regarding a given reality context within a given field of view comprises capturing the information using at least one camera.

4. The method of claim 1 further comprising:
capturing, substantially in real time, information regarding a viewer's present gaze direction with respect to the given field of view;
and wherein using, substantially in real time, the detected reality content for the given field of view to provide visually perceivable reality content augmentation to a person viewing the given field of view wherein the visually perceivable reality content augmentation is positionally visually synchronized with respect to at least one element of the given reality context comprises using the viewer's present gaze direction with respect to the given field of view in conjunction with the detected reality content for the given field of view to achieve visual positional synchronization between the given reality context as viewed by the viewer and the visually perceivable reality content augmentation.

5. The method of claim 4 wherein achieving the visual positional synchronization comprises at least one of:
translating;
rotating; and
skewing;
the visually perceivable reality content augmentation based on at least one of:
gaze directionality as pertains to the person;
eye position of the person;
head position of the person; and
a distance from at least one eye of the person to a display of the visually perceivable reality content augmentation.

6. The method of claim 1 wherein processing, substantially in real time, the information regarding a given reality context to provide detected reality content for the given field of view comprises processing the information regarding a given reality context to detect at least one of:
object edges;
object shape;
object distance;
relative position of objects;
textual information;
object recognition;
at least one color;
a temporally dynamic object.

7. The method of claim 1 wherein providing visually perceivable reality content augmentation to a person viewing the given field of view comprises providing a display of the visually perceivable reality content augmentation.

8. The method of claim 7 wherein providing a display of the visually perceivable reality content augmentation comprises providing the display on at least one of:
a substantially transparent surface; and
a mirror.

9. The method of claim 8 wherein providing the display on a substantially transparent surface comprises projecting the display on the substantially transparent surface.

10. The method of claim 9 wherein the substantially transparent surface comprises at least one of:
a vehicle operator's windscreen;
corrective lens eyewear;
sunglasses.

11. The method of claim 1 further comprising:
automatically controlling provision of the visually perceivable reality content augmentation to a person viewing the given field of view as a function, at least in part, of:
a level of confidence with respect to likely accuracy of the detected reality content for the given field of view;
distance to a detected object;
a personal preference of the person;
the person's level of experience with respect to a particular activity;
the person's level of skill with respect to a particular activity;
the person's age;
an object's occlusion;
at least one environmental condition.

12. The method of claim 1 wherein providing the visually perceivable reality content augmentation to a person viewing the given field of view further comprises using color to visually augment at least one real object in the given field of view.

13. The method of claim 12 wherein using color to visually augment at least one real object in the given field of view further comprises selecting from a plurality of candidate colors to provide a selected color to use when visually augmenting the at least one real object in the given field of view.

14. The method of claim 1 wherein providing the visually perceivable reality content augmentation to a person viewing the given field of view further comprises using at least one of:
a line;
a curve;
a two-dimensional shape;
text;
to visually augment at least one real object in the given field of view.

15. The method of claim 1 wherein providing the visually perceivable reality content augmentation to a person viewing the given field of view further comprises using at least one of:
a blinking property;
a selectively variable opaqueness property;
to visually augment at least one real object in the given field of view.

16. A visual reality augmentation apparatus comprising:
a substantially real time reality context input stage having a field of view input and a captured reality context information output;
a substantially real time reality content detector having an input operably coupled to the captured reality content information output of the substantially real time reality context input stage and having a detected content output;
a substantially real time and substantially transparent augmented reality content display responsive to the detected content output of the reality content detector wherein at least one real object within a field of view as corresponds to the field of view input appears visually augmented by a positionally synchronized augmentation element when view by a viewer.

17. The visual reality augmentation apparatus of claim 16 wherein the substantially real time reality context input stage comprises at least one camera.

18. The visual reality augmentation apparatus of claim 16 further comprising:
a viewer's present direction-of-gaze detector;
and wherein the substantially real time and substantially transparent augmented reality content display is further responsive to the viewer's present direction-of-gaze detector.

19. The visual reality augmentation apparatus of claim 16 wherein the substantially real time and substantially transparent augmented reality content display further comprises means for positionally synchronizing the at least one real object within the field of view with the augmentation element as a function, at least in part, of at least one of:
the viewer's gaze direction;
a relative position of a viewer's eyes with respect to the substantially transparent augmented reality content display.

20. The visual reality augmentation apparatus of claim 16 wherein the substantially real time and substantially transparent augmented reality content display further comprises a vehicle operator's windscreen.
